(19) United States
(12) Patent Application Publication
(10) Pub. No.: US 2011/0205449 A1
(43) Pub. Date: Aug. 25, 2011

(54) LIGHTING DEVICE, DISPLAY DEVICE AND TELEVISION RECEIVER

(75) Inventor: Mayumi Nakamura, Osaka-shi (JP)

(73) Assignee: SHARP KABUSHIKI KAISHA, Osaka-shi, Osaka (JP)

(21) Appl. No.: 13/123,535

(22) PCT Filed: Jul. 17, 2009
(86) PCT No.: PCT/JP2009/062945

§ 371 Date: Apr. 11, 2011

(30) Foreign Application Priority Data
Oct. 22, 2008 (JP) 2008-271919

(51) Int. Cl. H04N 5/66; F21V 11/00; F21V 8/00; F21V 13/02; G02F 1/13357

(52) U.S. Cl. 348/739; 362/235; 362/613; 362/612; 349/64; 348/E05.133

(57) ABSTRACT

A lighting device 30 includes a light source unit 32 and an optical member 60. The light source unit 32 includes a plurality of planar light sources 31 arranged along a planar direction. The optical member 60 is arranged on a light exit surface side of the light source unit 32. The optical member 60 includes boundary overlapping portions 62T and 62Y, and light source overlapping portions 63. The boundary overlapping portions 62T and 62Y overlap boundaries 55T and 55Y between the adjacent planar light sources 31 of the light source unit 32. The light source overlapping portions 63 overlap the planar light sources 31. The boundary overlapping portions 62T and 62Y have higher light transmissivity than the light source overlapping portions 63.

### TECHNICAL FIELD

The present invention relates to a lighting device including a plurality of planar light sources, a display device and a television receiver.

### BACKGROUND ART

A lighting device including a plurality of planar light sources such as a lighting device disclosed in Patent Document 1 is known. The lighting device includes lighting units each including a plurality of planar light sources. The lighting units can provide high contrast because brightness can be controlled for each planar light source. Furthermore, power consumption is low in comparison to a light unit in which an entire area is continuously illuminated.

Patent Document 1: Japanese Published Patent Application No. 2001-75096

### PROBLEM TO BE SOLVED BY THE INVENTION

In such a lighting device including the planar light sources, gaps are commonly provided between the adjacent planar light sources to allow thermal expansion and contraction of the planar light sources. However, light is not emitted in areas corresponding to the gaps (boundary areas between the adjacent planar light sources) and thus that areas are darker than other areas. As a result, brightness becomes uneven.

The lighting device usually includes a diffuser to provide uniform brightness with light from the light source unit. If the adjacent planar light sources are both lit with high brightness, brightness in a boundary area between the adjacent planar light sources may be significantly different from the brightness of the planar light sources. Therefore, even brightness cannot be achieved with the diffuser sheet and high display quality cannot be provided.

### DISCLOSURE OF THE PRESENT INVENTION

The present invention was made in view of the foregoing circumstances. An object of the present invention is to provide a lighting device, a display device and a television receiver all configured to provide display with high quality.

### PROBLEM TO BE SOLVED BY THE INVENTION

To solve the above problem, a lighting device of the present invention includes a light source unit and an optical member that includes a light source overlapping portions and a boundary overlapping portions having higher light transmissivity than that of the light source overlapping portions. The light source unit includes a plurality of planar light sources arranged along a planar direction. The optical member is arranged on a light exit surface side of the light source unit. The boundary overlapping portions of the optical member overlap boundaries between the adjacent planar light sources of the light source unit. The light source overlapping portions overlap the planar light sources.

With this configuration, a difference in brightness between the boundary overlapping portions and the light source overlapping portions is smaller than that between boundary overlapping portions and light source overlapping portions having the same light transmissivity. Therefore, uneven brightness is less likely to be recognized and thus high display quality can be achieved.

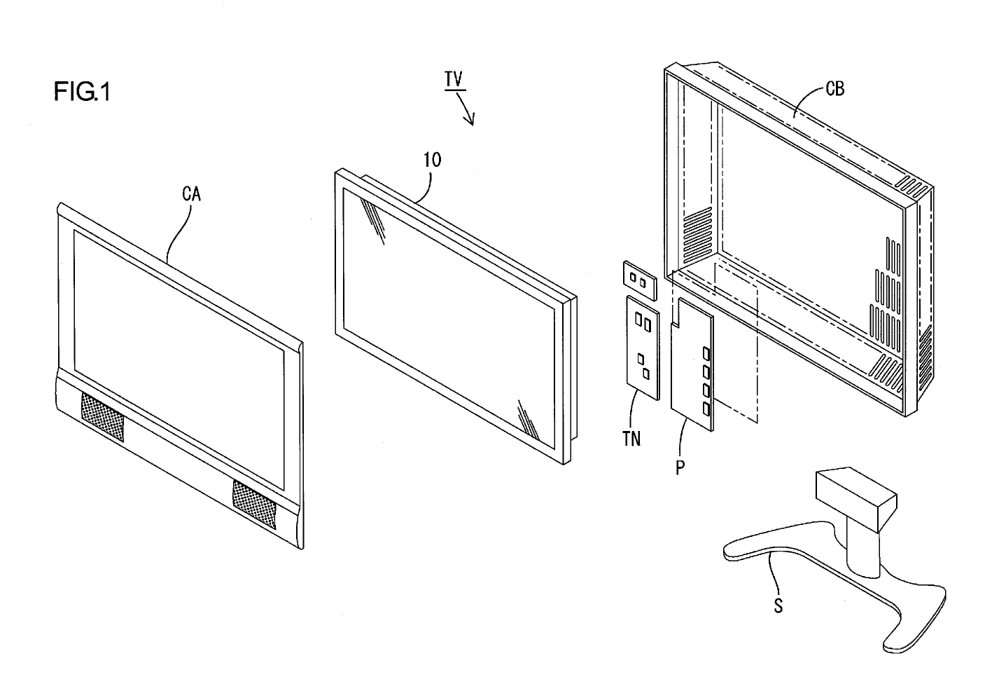

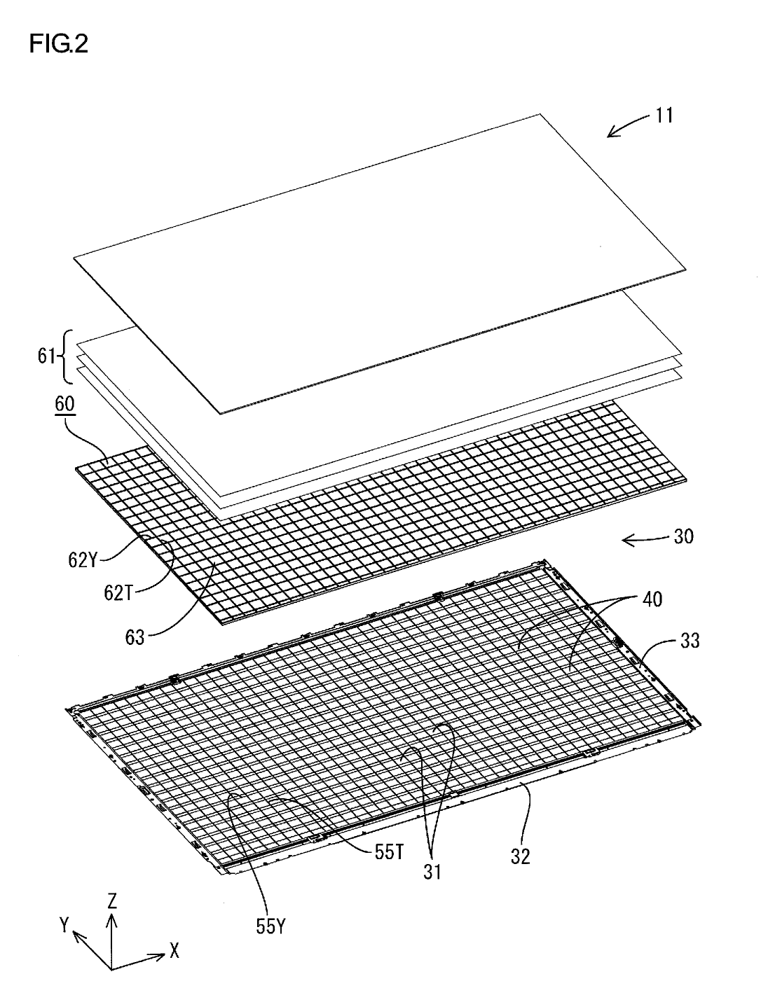

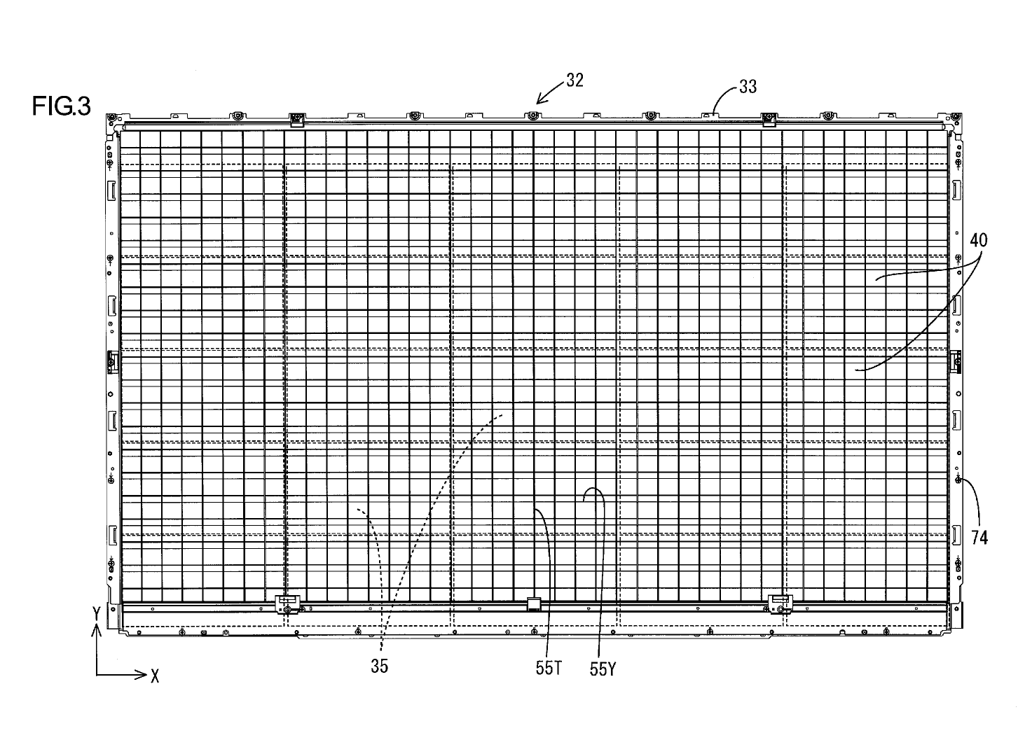

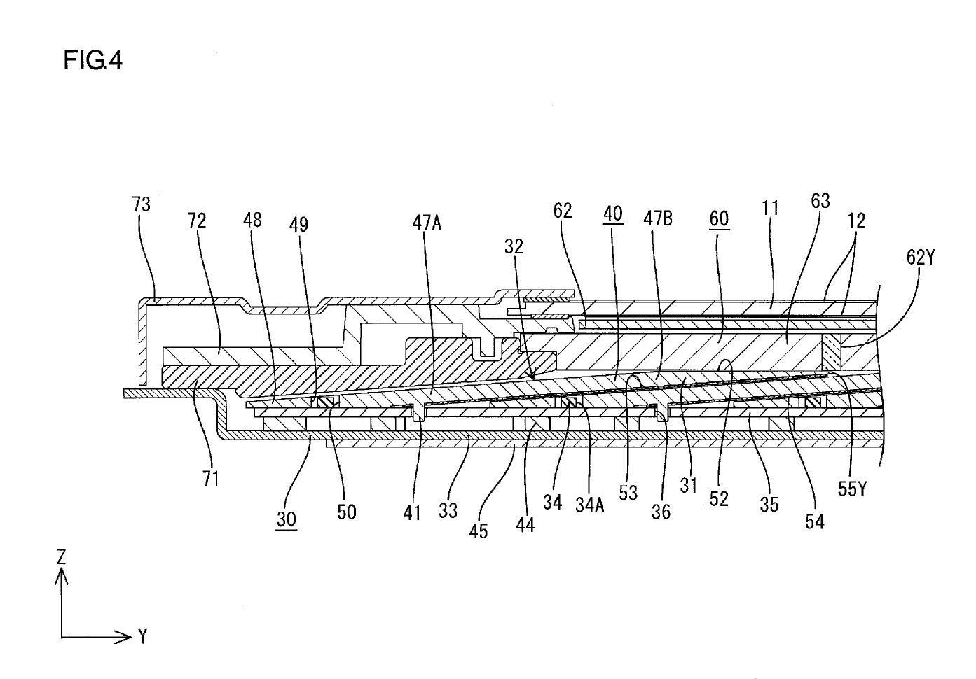

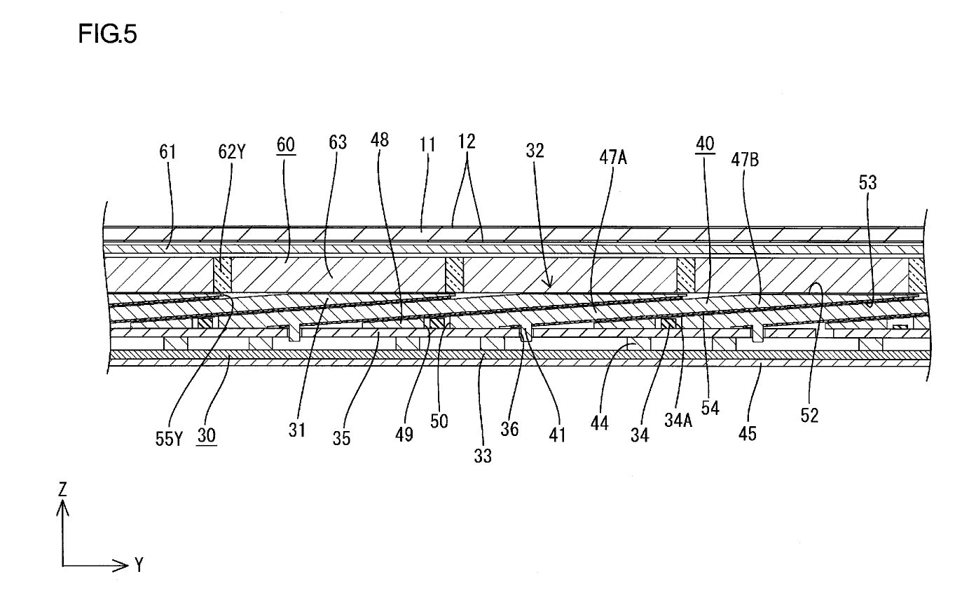

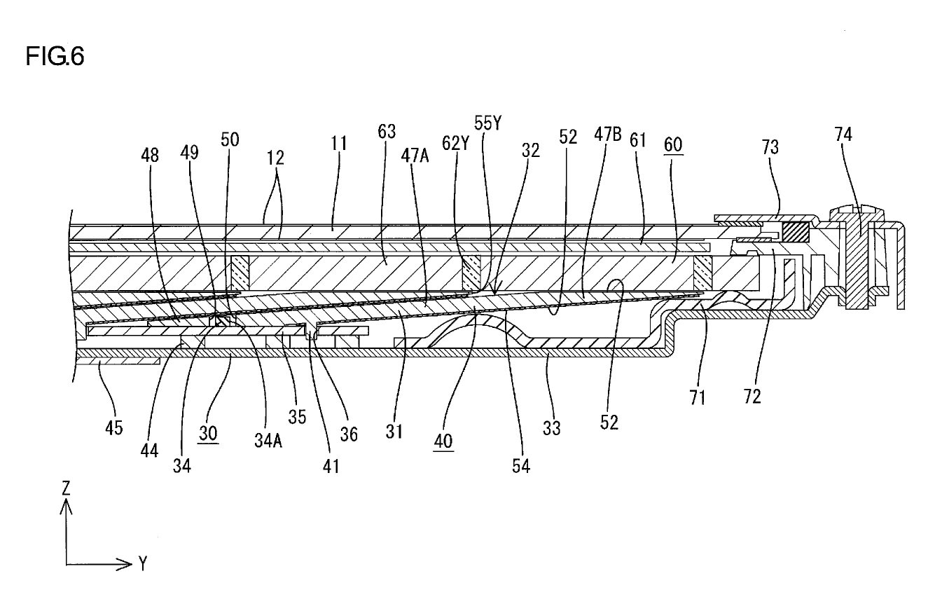

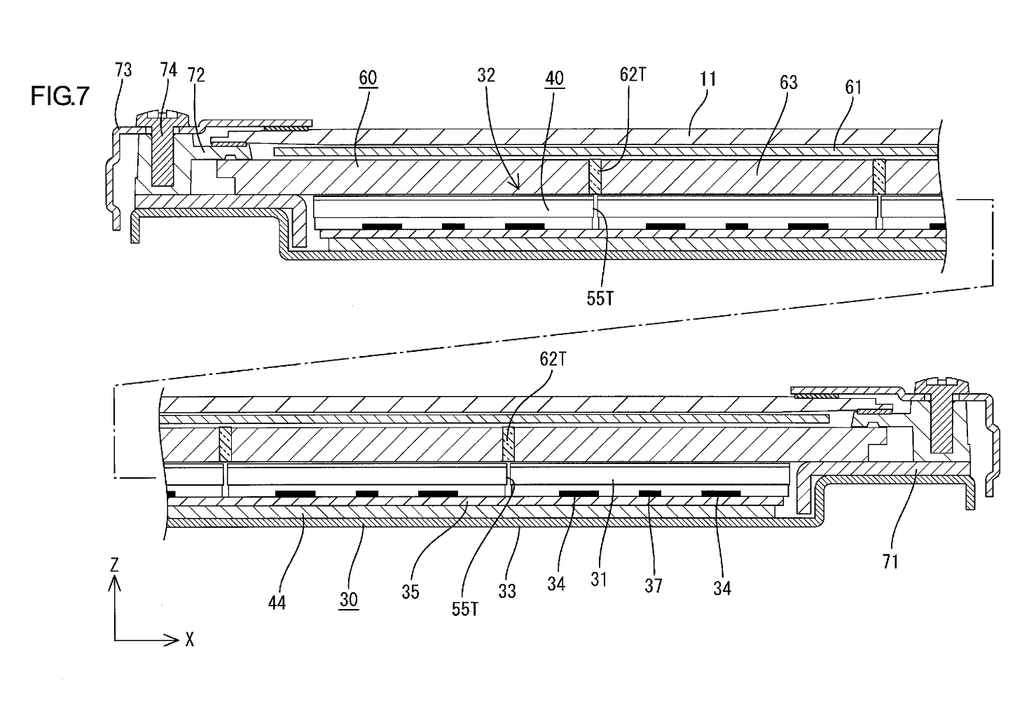

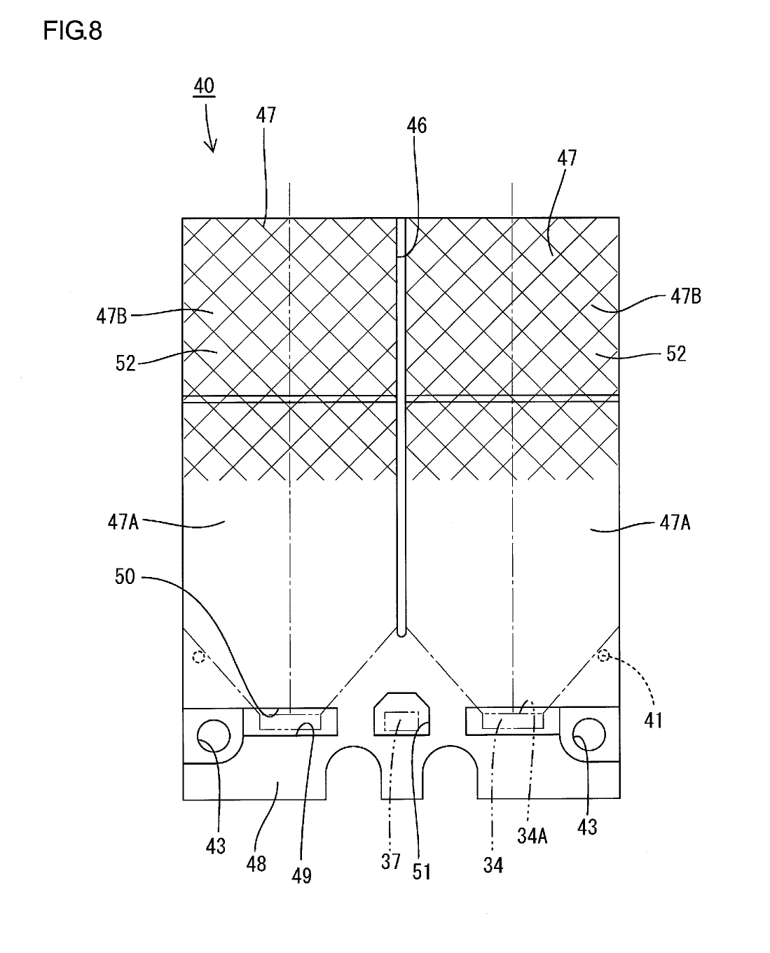

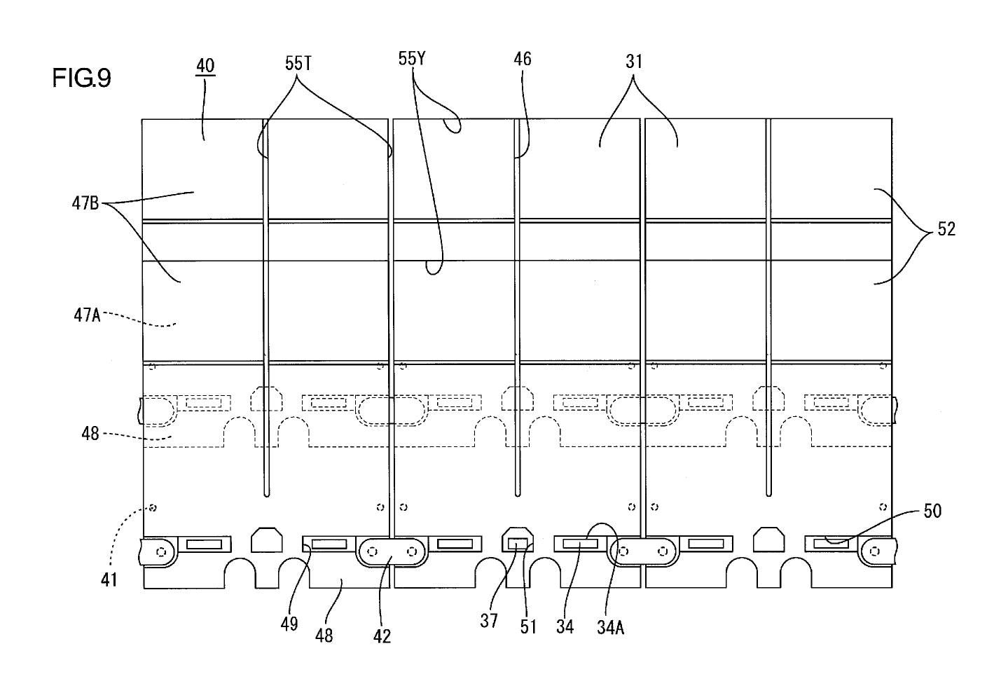

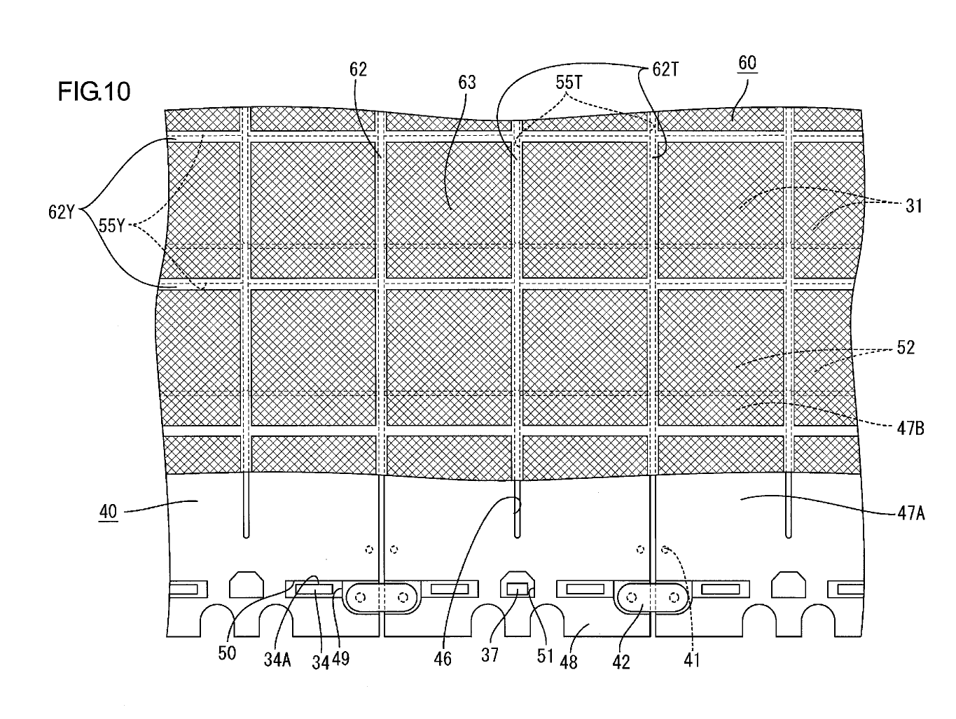

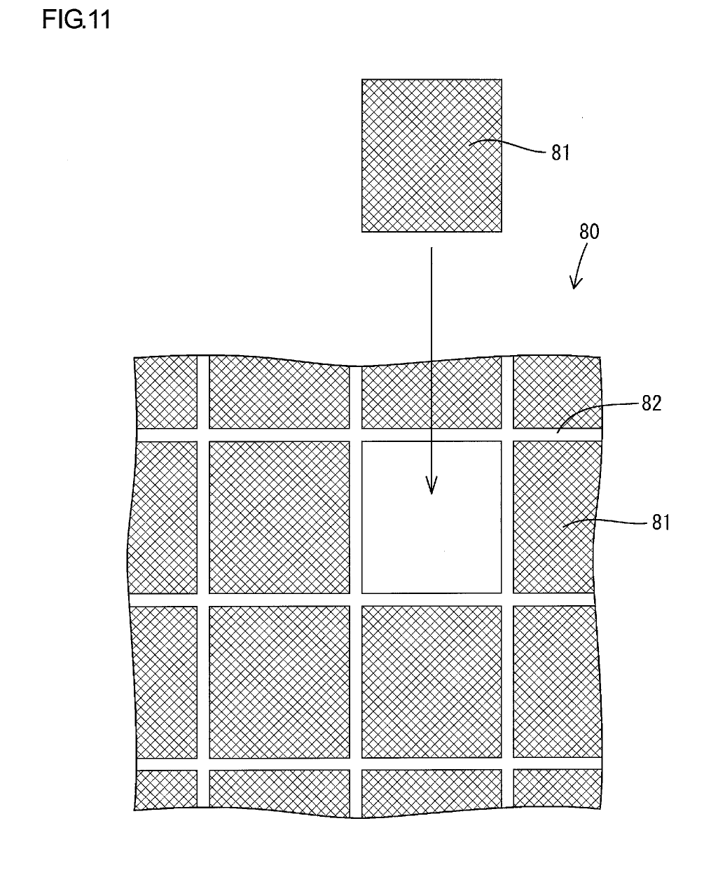

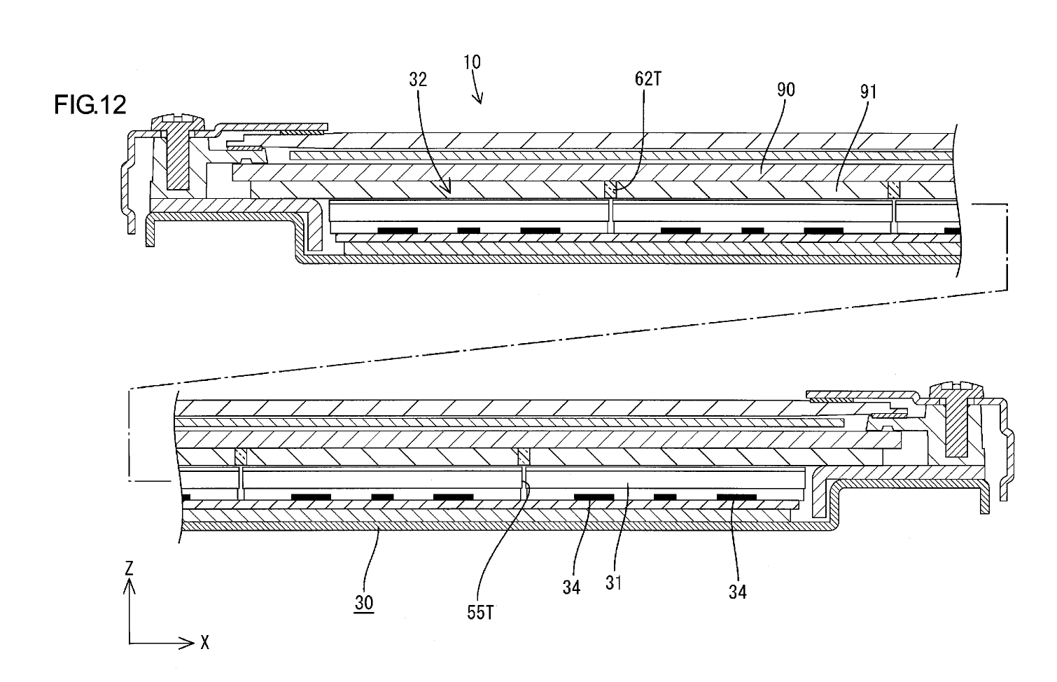

### BRIEF DESCRIPTION OF THE DRAWINGS

[FIG. 1] is an exploded perspective view illustrating a general construction of a television receiver according to an embodiment;

[FIG. 2] is an exploded perspective view illustrating a general construction of a liquid crystal panel;

[FIG. 3] is a front view of a light source unit;

[FIG. 4] is a cross-sectional view of an end section of a liquid crystal display device around an end of a short dimension of the liquid crystal display device;

[FIG. 5] is a cross-sectional view of a middle section of the liquid crystal display device around a middle of a short dimension of the liquid crystal display device;

[FIG. 6] is a cross-sectional view of the other end section of a liquid crystal display device around the other end of the short dimension of the liquid crystal display device;

[FIG. 7] is a cross-sectional view of end sections of the liquid crystal display device around ends of a long dimension of the liquid crystal display device;

[FIG. 8] is a front view of a light guide plate;

[FIG. 9] is a front view illustrating light guide plates in a parallel layout;

[FIG. 10] is a conceptual view of a light diffuser over planar light sources;

[FIG. 11] is a conceptual view of a light diffuser according to an embodiment (1); and

[FIG. 12] is a cross-sectional view of a liquid crystal display device according to an embodiment (2).

### BEST MODE FOR CARRYING OUT THE INVENTION

An embodiment of the present invention will be explained with reference to FIGS. 1 to 10.

In this embodiment, a television receiver TV including a liquid crystal display device 10 (a display device) will be explained. As illustrated in FIG. 1, the television receiver TV includes the liquid crystal display device 10, cabinets CA and CB, a power source P, and a tuner TN. The cabinets CA and CB sandwich the liquid crystal display device 10 therebetween. The tuner TN receives TV broadcasting. The liquid crystal display device 10 is held in a vertical position such that a display surface thereof is along the vertical direction and housed in the cabinets CA and CB. In descriptions below, the lower left side (the front side of the television receiver TV or the display side) of FIG. 1 is referred to as a front-surface side and the upper right side of FIG. 1 is referred to as a rear-surface side. The X direction in each drawing corresponds to the longitudinal direction of the liquid crystal display device 10. The Y direction corresponds to the short-side direction of the liquid crystal display device 10 (a positive side is an upper side and a negative side is a lower side). Z direction corresponds to the front-to-rear direction of the liquid crystal display device 10 (a positive side is the front-surface side and a negative side is the rear-surface side).

The liquid crystal display device 10 has a landscape rectangular overall shape when viewed from the front or the rear. As illustrated in FIG. 2, the liquid crystal display device 10 includes a liquid crystal panel 11 (corresponding to a display panel in claims) which is configured to display images and a backlight unit 30 (corresponding to a lighting device in claims) which is an external light source for illuminating the liquid crystal panel 11. The liquid crystal panel 11 and the backlight unit 30 are held together by holding members including a bezel 73.

The liquid crystal panel 11 includes a pair of transparent glass substrates (capable of light transmission) and a liquid crystal layer (not shown). Each glass substrate has a landscape rectangular shape. The liquid crystal layer is provided between the substrates. Optical characteristics of the liquid crystal layer change according to application of voltage. Polarizing plates 12 are attached to the front and the rear surfaces of the liquid crystal panel 11 (see FIGS. 4 to 6).

The backlight unit 30 is a so-called direct backlight unit 30 and arranged closely behind the liquid crystal panel 11. The backlight unit 30 includes a light source unit 32 in which a plurality of planar light sources 32 are arranged along the planar direction.

The light source unit 32 includes a chassis 33 formed in a shallow-tray-like shape recessed toward the rear-surface side (an opposite side from the liquid crystal panel 11). The chassis 33 is made of metal. A plurality of the LED boards on which surface-mount-type LEDs 34 (primary light sources in claims) are mounted are arranged on a bottom surface (i.e., the front surface) of the chassis 33.

Each LED board 35 is made of synthetic resin and the surfaces thereof are in white that provides high light reflectivity. The LED board 35 is formed in a plate-like shape having a landscape rectangular plan view when viewed from the front or the rear. The LED boards 35 are arranged on the bottom surface of the chassis 33 such that the longitudinal direction thereof matches the longitudinal direction of the chassis 33 (see FIG. 3). About an entire bottom surface of the chassis 33 is covered with the plurality of the LED boards 35. Specifically, it is covered with five along the long-side direction of the chassis 33 by five along the short-side direction and a total of 25 LED boards 35.

Wiring patterns that are metal films are formed on each LED board 35 and the LEDs 34 are mounted in predetermined locations on the LED board 35. The LEDs 34 are arranged in a planar grid pattern on each LED board 35 at predetermined intervals along the long side and the short side of the LED board 35. Specifically, eight along the long-side direction of the LED board 35 by four along the short-side direction thereof and a total of 32 LEDs 34 are arranged at regular intervals. The LED boards 35 are electrically connected to a control board (not shown) for controlling driving of the LEDs 34.

Each LED board 35 has positioning holes 36 in which positioning pins 41 of light guide plates 40, which will be explained later, are fitted (see FIGS. 4 to 6). It also has clip insertion holes (not shown) in which clips 42 for fixing the light guide plates 40 to the LED board 35 are inserted (see FIG. 9). The LED boards 35 are fixed to the bottom plate of the chassis 33 with screws, which are not shown.

Heat-transfer members 44 are provided between the bottom surface (or the front surface) of the chassis 33 and the LED boards 35. Each heat-transfer member 44 is made of synthetic resin or metal having high heat conductivity. A heat sink 45 is attached to the outer surface (or the rear surface) of the chassis 33. The heat sink 45 is made of synthetic resin or metal having high heat conductivity.

The LEDs 34 are side emitting LEDs. Each LED 34 has a block-like overall shape and a side surface thereof is a light-emitting surface 34A. The LEDs 34 are arranged such that the longitudinal direction thereof matches the longitudinal direction of the LED boards 35 and soldered to the LED boards 35. The side surface 34A of each LED 34 is set substantially perpendicular to the short side of the LED board 35. A light axis is substantially parallel to the front surface of the LED board 35. Each LED 34 includes three different kinds of the LED chips (not shown) with different main emission wavelengths. Specifically, each LED chip emits a single color of light of red (R), green (G) or blue (B).

A plurality of the light guide plates 40 are arranged on the front surface of each LED board 35. Each light guide plate 40 is made of nearly transparent synthetic resin (highly capable of light transmission), for instance, polycarbonate. The light guide plate 40 has a refraction index significantly higher than that of air and a rectangular overall shape when viewed from the front or the rear. The light guide plate 40 is arranged on the LED board 35 such that the longitudinal direction thereof matches the light axis of the LED 34.

As illustrated in FIG. 8, each light guide plate 40 has a slit 46 formed so as to divide the short dimension of the light guide plate 40 in half (i.e., the slit 46 is located at the center of the short dimension of the light guide plate 40). The slit 46 runs from one end of the long dimension of the light guide plate 40 toward the other end. One end of the slit 46 is open and the other end is closed.

Each light guide plate 40 includes unit light guide members 47 (corresponding to light guide members in claims) on respective sides of the slit 46. The light guide members 47 are optically independent from each other. Peripheral surfaces of the light guide plate 40 are substantially perpendicular to the front surface of the LED board 35.

A part of each light guide plate 40 close to the other end (a part in which the slit 46 is not formed) is a mounting portion 48 mounted to the LED board 35. In the mounting portion 48, light source holding spaces 49 for holding the LEDs 34 are provided. Each light source holding space runs through the light guide plate 40 in the thickness direction and long in the short-side direction of the light guide plate 40. A surface that faces the light-exiting surface of the LED 34 among inner peripheral surfaces is a light entrance surface 50 through which light from the LED 34 enters.

Each light guide plate 40 has a pair of the light source holding spaces 49 formed in locations predetermined distance away from each other in the short-side direction thereof. Each light source holding space 49 is formed around the middle of the short dimension of the corresponding unit light guide member 47. Namely, it is formed around the midpoint between the slit 46 and the either end of the short dimension (or the long side) of the light guide plate 40. Each light source holding space 49 is formed in a location such that rays of light emitted from the LED 34 do not enter the adjacent unit light guide member 47.

The mounting portion has clip insertion holes 43 in which the clips 42 for mounting the light guide plate 40 to the LED board 35 are inserted. The clip insertion holes 43 are formed at ends of the mounting portion 48 in the width direction of the mounting portion 48 (ends of the short dimension of the light guide plate 40). The clips 42 passed through the clip insertion holes 43 are inserted in the clip insertion holes of the LED board 35. As a result, the light guide plate 40 is held to the LED board 35 in an initial condition in which it is mounted.

Each mounting portion 48 has a sensor holding space 51 for holding a photo sensor 37 mounted on the LED board 35. The sensor mounting space 51 is provided between the light source holding spaces 49 (on an extended line of the slit 46).

Each unit light guide member 47 has a light guide portion 47A and a light exit portion 47B. The light guide portion 47A guides light from the LED 34 such that the light does not exit to outside. The light guided by the light guide portion 47A exits from the light exit portion 47B. A part of the unit light guide member 47 on the light source holding space 49 side is the light guide portion 47A and the other part is the light exit portion 47B. Light emitted from the LED 34 is guided to the light exit portion 47B with total reflection that occurs repeatedly. It exits from a light exit surface 52 of the light exit portion 47B. The unit light guide member 47 and the LED 34 form the planar light source 31. Each unit light member 47 has a positioning pin 41 for positioning the light guide plate 40 to the LED board 35 in a location close to the mounting portion 48. When the positioning pins 41 are inserted in the positioning holes 36 of the LED board 35, the light guide plate 40 is positioned to the LED board 35.

The surfaces of the light exit portions 47B are the light exit surfaces 52 of each unit light guide member 47. In FIG. 8, shaded areas correspond to the light exit surfaces 52. Each light exit surface 52 of the unit light guide member 47 has a rectangular shape that is slightly long in the longitudinal direction of the light guide plate 40 when viewed from the front or the rear. A large part of the light exit surface 52 is a flat surface substantially parallel to the surface of the LED board 35 (see FIGS. 4 to 6). The mounting portion 48 and the light guide portions 47A of each light guide plate 40 are non-luminance portions.

The rear surface of each light exit portion 47B (the opposite surface from the light exit surface 52) is a scattering surface 53 that scatters light. The scattering surface 53 has microscopic asperities, which are not shown. Specifically, the scattering surface 53 has a large number of perforations that extend linearly along the short-side direction of the light guide plate 40. Intervals between lines of the perforations are large on the light guide portion 47A side and small on the front end of the light guide portion 47B. They gradually decrease from the light guide portion 47A side to the front end of the light guide portion 47B. With this configuration, differences in brightness on the side close to the LED 34 and on the side away from the LED 34 are significantly decreased. As a result, substantially even brightness can be achieved. The rear surface of each unit light guide member 47 is sloped so as to be gradually away from the LED board 35 along a direction from the mounting portion 48 toward the front end of the light exit portion 47B.

The reflection sheet 54 is attached to the rear surface of each light guide plate 40. The reflection sheet 54 is made of synthetic resin in white that provides high light reflectivity. The reflection sheet 54 is bonded to the light guide plate 40 with transparent adhesives (not shown).

The light guide plates 40 are arranged on the front surface of the LED board 35 such that the light exit surfaces 52 of the unit light guide members 47 (the light exit surfaces 52 of the planar light sources 31) are aligned along the planar direction (substantially parallel to the front surface of the LED board 35). The light guide plates 40 are arranged on the front surface of the LED board 35 with the mounting portions 48 on the lower side (on a negative side of the Y direction in the drawing) and the light exit portions 47B on the upper side (on a positive side of the Y direction in the drawing).

The light guide plates 40 are arranged in line with ends of the long dimensions thereof overlap each other on one side. Lines of the light guide plates 40 are away from each other in the short-side direction with predetermined intervals (see FIG. 9). In each line of the light guide plates 40, the light exit portion 47B of the light guide plate 40 (one that is on the lower side) overlaps the non-luminance portion (a portion from the mounting portion 48 to the light guide portion 47A) of another (one that is on the upper side) from the front-surface side. The light exit surfaces 52 of the light guide plates 40 are arranged in lines along the short-side direction of the LED board 35 substantially without gaps.

Lines of the light guide plates 40 are arranged parallel to each other in the longitudinal direction of the LED board 35 with predetermined gaps (in the same size as the slits 46). Each line of the light guide plates 40 is arranged so as not to overlap another line of the light guide plates 40. All planar light sources 31 are arranged such that the light exit surfaces 52 are closely placed about the entire surface of the LED board 35. The light exit surfaces 52 of the planar light sources 31 closely placed form the light exit surface of the light source unit 32.

The light exit surface of the light source unit 32 includes horizontal and vertical boundaries 55T and 55Y. The vertical boundaries 55T that extend along the short-side direction of the LED board 35 include the slits 46 of the light guide plates 40 and the gaps between the adjacent light guide plates 40. The width of each vertical boundary 55T is equal to the width of the gap between light exit surfaces 52 of the adjacent planar light sources 31. The horizontal boundaries 55Y that extend along the longitudinal direction of the LED board 35 include the front edges of the light exit surfaces 52 of the planar light sources 31 (the edges away from the light guide portions 47A).

The backlight unit 30 includes a diffuser 60 (an optical member in claims) and an optical sheet 61. The diffuser 60 is provided to achieve uniform brightness and arranged close to the light exit surfaces 52 of the planar light sources 31 on the light exit surface 52 side of the light source unit 32 (on the front surface side of the chassis 33). The diffuser 60 will be explained in detail later. The optical sheet 61 is arranged on the front-surface side of the diffuser 60 (on the liquid crystal panel 11 side). The optical sheet 61 includes a diffuser sheet, a lens sheet and a reflection-type polarizing sheet layered in this order from the rear-surface side (see FIG. 2).

A holding member 71 is attached to outer edge areas of the chassis 33. The holding member 71 holds entire outer edge areas of the diffuser 60 from the rear-surface side. A frame 72 is provided between the outer edge areas of the diffuser 60 and the outer edges of the liquid crystal panel 11. The bezel 73 is arranged on the front surface of the outer edge areas of the liquid crystal panel 11. The outer edge areas of the diffuser 60 are sandwiched between the holding member 71 and the frame 72. The outer edge areas of the liquid crystal panel 11 are sandwiched between the bezel 73 and the frame 72. The optical sheet 61 is sandwiched between the diffuser 60 and the liquid crystal panel 11. See FIGS. 4 to 6 for the above configurations. The liquid crystal display device 10 is assembled with the bezel 73, the frame 72 and the chassis 33 fixed together with screws 74 at multiple locations (see FIGS. 6 and 7).

The diffuser 60 is formed in a plate-like overall shape having substantially the same plan view as the light source unit 32 (see FIG. 2). The diffuser 60 includes boundary overlapping portions 62 and light source overlapping portions 63 (see FIG. 10). The boundary overlapping portions 62 overlap the boundaries 55T and 55Y of the light source unit 32. The light source overlapping portions 63 overlap the planar light sources 31. The light transmissivity of the boundary overlapping portions 62 is different from that of the light source overlapping portions 63.

The boundary overlapping portions form a grid-like overall shape and includes vertical overlapping portions 62T and horizontal overlapping portions 62Y. The vertical overlapping portions 62T overlap the vertical boundaries 55T between the planar light sources 31. The horizontal overlapping portions 62Y overlap the horizontal boundaries 55Y between the planar light sources 31. The vertical overlapping portions 62T and the horizontal overlapping portions 62Y are substantially perpendicular to each other. The widths of the vertical overlapping portions 62T and the horizontal overlapping portions 62Y are constant.

The vertical overlapping portions 62T and the horizontal overlapping portions 62Y have a width larger than that of the vertical boundaries 55T and the horizontal boundaries 55Y of the planar light sources 31. Center areas of the vertical overlapping portions 62T and the horizontal overlapping portions 62Y overlap around the centers thereof with respect to the width direction overlap the vertical boundaries 55T and the horizontal boundaries 55Y, respectively. Side areas close to sides with respect to the width direction extend from the sides of the boundaries and overlap the side-edge areas of the planar light sources 31 (the side-edge areas of the light exit surfaces 52) which are arranged on sides of the vertical boundaries 55T or the horizontal boundaries 55Y.

The light source overlapping portions 63 are areas of the diffuser 60 surrounded by the boundary overlapping portions 62 (surrounded by the vertical overlapping portions 62T and the horizontal overlapping portions 62Y). Each light source overlapping portion 63 is formed in a substantially square shape slightly smaller than the light exit surface 52 of the planar light source 31. A thickness of each light source overlapping portion 63 is equal to that of the boundary overlapping portion 62. The entire front and the rear surfaces of the diffuser 60 are flat surfaces.

Each light source overlapping portion 63 is made of light-scattering resin composition including a resin having high light transmissivity (highly transparent) and diffusing particles having different refraction from the resin and mixed in the resin. A base material of the light-scattering resin composition is a thermoplastic, for example, acrylic resin, polycarbonate resin, cyclic olefin resin, polyvinyl chloride resin, polystyrene resin. Various kinds of materials can be used for the light diffusing particles, for example, glass, silica dioxide, calcium carbonate, zirconia, silicon resin, yttrium oxide, gadolinium, and lead tungsten. The diffusing particles preferably have the same level of transparency as the resin.

The boundary overlapping portions 62 are made of resin without light diffusing particles and the resin is the same kind as the base material of the light source overlapping portions 63. The boundary overlapping portions 62 diffuse light at a lower level than the light source overlapping portions 63 and have higher light transmissivity than the light source overlapping portions 63.

The light source overlapping portions 63 and the boundary overlapping portions 62 of the diffuser 60 are integrally formed by molding. The diffuser 60 is prepared as follows, for example. The light source overlapping portions 63 formed substantially in a square shape in advance are arranged at predetermined intervals (at the same intervals equal to the width of the boundary overlapping portions 62). Melted resin is poured into the gaps between the light source overlapping portions 63 and the boundary overlapping portions 62 are formed. Alternatively, the boundary overlapping portions 62 are formed in advance and then melted light-diffusing resin composite is poured into open areas. As a result, the diffuser 60 is formed in a single plate-like shape.

Next, functions and effects of this embodiment having the above configuration will be explained.

In this embodiment, the diffuser 60 includes the boundary overlapping portions 62 and the light source overlapping portions 63. The boundary overlapping portions 62 overlap the boundaries between the adjacent light exit surfaces 52 of the light source unit 32. The light source overlapping portions 63 overlap the planar light sources 31. The boundary overlapping portions 62 have higher light transmissivity than the light source overlapping portions 63.

If the adjacent light exit surfaces 52 are both illuminated at a high brightness level, most rays of light exiting from large areas (center areas) of the light exit surfaces 52 enter the light source overlapping portions 63. Rays of light exiting from peripheral areas of the light exit surfaces 52 and rays of light traveling in planar directions of the light exit surfaces 52 enter the boundary overlapping portions 62. The rays of light in the light source overlapping portions 63 diffuse and exit from the front surfaces of the light source overlapping portions 63 to the front-surface side. The rays of light in the boundary overlapping portions 62 exit from the front surfaces of the boundary overlapping portions 62 to the front-surface side without diffusion. The amount of light exiting from the front surfaces of the light source overlapping portions 62 is larger than an amount of light diffused by a regular diffuser. With the regular diffuser, the light is diffused at the same level in the boundary overlapping portions as in the light source overlapping portions. Namely, in comparison to the boundary overlapping portions 62 and the light source overlapping portions 63 having the same light transmissivity, a difference in brightness between the boundary overlapping portions 62 and the light source overlapping portions 63 is small. Therefore, the uneven brightness is less likely to be recognized and thus high display quality can be achieved.

The boundary overlapping portions 62 are made of transparent resin. The rays of light from the planar light sources 31 travel through the boundary overlapping portions 62 without diffusion. Therefore, the difference in brightness between the boundary overlapping portions 62 and the light source overlapping portions 63 further decreases and thus the uneven brightness is less likely to be recognized.

Each boundary overlapping portion 62 has the width so as to overlap the end areas of the light exit surfaces 52 located adjacent to each other via the boundary. With this configuration, the amount of light traveling through the boundary overlapping areas 62 increases. A result, the difference in brightness between the boundary overlapping portions 62 and the light source overlapping portions 63 further decreases.

The light source overlapping portions 63 and the boundary overlapping portions 62 are integrally formed. With this configuration, the diffuser 60 can be handled as a single part. In comparison to those provided separately, it can be easily handled and the backlight unit 30 can be easily produced.

### Other Embodiments

The present invention is not limited to the above embodiments explained in the above description. The following embodiments may be included in the technical scope of the present invention, for example.

(1) In the above embodiment, the light source overlapping portions 63 and the boundary overlapping portions 62 are integrally formed in the diffuser 60. However, a diffuser having light source overlapping portions and boundary overlapping portions separately formed may be used. The separate light source overlapping portions and boundary overlapping portions may be attached together so as to be removable. As illustrated in FIG. 11, a diffuser 80 includes boundary overlapping portions 82 and open areas corresponding to light source overlapping portions 81. Each light source overlapping portion 81 is slightly larger than the corresponding open area surrounded by the boundary overlapping portions 82. The light source overlapping portions 81 are press-fitted in the respective open areas. If defects are found in the light source overlapping portions 81 or the boundary overlapping portions 82, only the defective light source overlapping portions 81 or the defective boundary overlapping portions 82 need to be replaced. In comparison to a diffuser that needs to be replaced entirely, waste can be reduced. The light source overlapping portions and the boundary overlapping portion may have engaging structures and engaged with each other with the engaging structures.

(2) In the above embodiment, a single diffuser 60 is provided. However, multiple diffusers may be provided in layers. In FIG. 12, two diffusers 90 and 91 are layered. In this case, only the rear diffuser 91 may have boundary overlapping portions 92 and light source overlapping portions 93. Furthermore, only the front diffuser may have boundary overlapping portions and light source overlapping portions or both diffusers may have the boundary overlapping portions and the light source overlapping portions.

(3) In the above embodiment, the boundary overlapping portions 62 are made of the same kind of resin as the base material of the light source overlapping portions 63. However, the boundary overlapping portions may be made of a different kind of resin from the base material of the light source overlapping portions.

(4) In the above embodiment, the boundary overlapping portions 62 are made of resin without the diffusing particles. However, the boundary overlapping portions may include the diffusing particles at a concentration lower than the light source overlapping portions.

(5) In the above embodiment, the boundary overlapping portions 62 include the vertical overlapping portions 62T that overlap the vertical boundaries 55T and the horizontal overlapping portions 62Y that overlap the horizontal boundaries 55Y. However, the boundary overlapping portions 62 may have only vertical overlapping portions.

(6) In the above embodiment, the width of each boundary overlapping portion 62 is defined such that the boundary overlapping portion 62 overlaps the edge portions of the light exit surfaces 52 arranged adjacently to each other via the boundary. However, the width of each boundary overlapping portion may be defined such that the boundary overlapping portion overlaps at least one of the edge portions of the light exit surfaces 52 arranged adjacently to each other via the boundary.

(7) In the above embodiment, the light source overlapping portions 63 of the diffuser 60 are made of the light-diffusing resin composites. The front and the rear surfaces of the light overlapping portions 63 are flat surfaces. However, the light source overlapping portions may be transparent resin plates with asperities for scattering light on the front surface. The surfaces of the light source overlapping portions and the boundary overlapping portions may have asperities. The light transmissivity of the boundary overlapping portions may be set higher than that of the light source overlapping portions by forming the asperities of the boundary overlapping portions in different shapes from those of the light source overlapping portions.

(8) In the above embodiment, the width of each boundary overlapping portion 62 is larger than that of the boundary. However, it may be equal to or smaller than that of the boundary.

(9) In the above embodiment, the widths of each vertical overlapping portion 62T and each horizontal overlapping portion 62Y of the boundary overlapping portions 62 are larger than the widths of each vertical boundary 55T and each horizontal boundary 55Y. However, only the width of each vertical overlapping portion may be larger than that of each vertical boundary 55T, and the width of each horizontal overlapping portion may be smaller than the width of each horizontal boundary 55Y.

(10) In the above embodiment, an entire part of each light source overlapping portion 63 in the thickness direction thereof is made of light-diffusing resin composite. However, one surface of a part of each light source overlapping portion made of light-diffusing resin composite maybe covered with a transparent resin and provided as a single part.

1. A lighting device comprising:
a light source unit including a plurality of planar light sources arranged along a planar direction; and
an optical member arranged on a light exit surface of the light source unit and including boundary overlapping portions overlapping boundaries between planar light sources of the light source unit arranged adjacently to each other and light source overlapping portions overlapping the planar light sources, the boundary overlapping portions having a light transmissivity higher than the light source overlapping portions.

2. The lighting device according to claim 1, wherein:
the optical member is a diffuser; and
the boundary overlapping portion has a light transmissivity lower than the light source overlapping portion.

3. The lighting device according to claim 1, wherein:
the optical member is a diffuser made of transparent resin with diffusing particles scattered therein; and
the boundary overlapping portion includes the diffusing particles at a lower concentration than the light source overlapping portion.

4. The lighting device according to claim 3, wherein the boundary overlapping portion is made of transparent resin without the diffusing particles.

5. The lighting device according to claim 1, wherein the boundary overlapping portion has a width defined such that each boundary overlapping portion overlaps at least one of the planar light sources arranged adjacently to each other via the boundary.

6. The lighting device according to claim 1, wherein the boundary overlapping portion has a width defined such that each boundary overlapping portion overlaps parts of the planar light sources arranged adjacently to each other via the boundary.

7. The lighting device according to claim 1, wherein the light source overlapping portions and the boundary overlapping portions are integrally formed.

8. The lighting device according to claim 1, wherein the light source overlapping portions and the boundary overlapping portions are separately prepared and attached together so as to be removable.

9. The lighting device according to claim 1, wherein each planar light source includes a primary light source and a light guide member configured to pass incident light from the primary light source.

10. The lighting device according to claim 9, wherein the primary light source is a point light source.

11. The lighting device according to claim 9, wherein the primary light source is an LED.

12. The lighting device according to claim 9, wherein
the light guide member includes a light exit portion through which light incident light from the primary light source exits and a light guide portion configured to guide the incident light from the primary light source to the light exit portion; and
the planar light sources are arranged such that the light guide portions overlap one another and the light exit portions face the optical member.

13. A display device comprising:
the lighting device according to claim 1; and
a display panel configured to provide display using light from the lighting device.

14. The display device according to claim 13, wherein the display panel is a liquid crystal panel including liquid crystals.

15. A television receiver comprising the display device according to claim 13.
